(19) United States
(12) Patent Application Publication
(10) Pub. No.: US 2007/0120373 A1
(43) Pub. Date: May 31, 2007

(54) LATCH MECHANISM

(75) Inventors: YUE-HAI ZHANG, Shenzhen (CN); HUNG-CHUN LU, Taipei Hsien (TW); WEN-KANG LO, Taipei Hsien (TW); CHIEN-LI TSAI, Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/556,172

(22) Filed: Nov. 3, 2006

(30) Foreign Application Priority Data
Nov. 15, 2005 (CN) 200520067928.8

(51) Int. Cl. E05C 1/04

(52) U.S. Cl. 292/42

(57) ABSTRACT

An exemplary latch mechanism includes a cover piece, and a latch member. The cover piece includes a base wall, and a flange extending perpendicularly from the base wall. The base wall includes a pair of slots defined therein, and a stop board. The flange includes a cutout defined therein. The latch member is slidably attached to the cover piece and includes a frame slidably received in the cutout of the flange, and a pair of arms having a pair of hooks depending therefrom to movably extend through the slots of the cover piece. The frame includes a rectangular hole defined therein, and a post extending into the hole from an inside wall thereof. A resilient member is fixed around the post and movably engages with the stop board.

### CROSS-REFERENCES TO RELATED APPLICATION

Related subject matter is disclosed in three co-pending U.S. Patent Applications entitled “Portable computer having improved latch mechanism,” (Ser. No. 11/188,548, filed on Jul. 25, 2005; Ser. No. 11/292,259, filed on Dec. 1, 2005; Ser. No. 11/272,531, filed on Nov. 10, 2005) and assigned to the same assignee with this application.

### BACKGROUND OF THE INVENTION

1. Field of the Invention

The present invention relates to latch mechanisms, and more particularly to a reliable latch mechanism.

2. Description of Related Art

Portable computers, such as laptop computers and notebook computers, have become increasingly popular for general use. Generally, a portable computer includes a cover unit, and a base unit pivotably connected with the cover unit. The cover unit is folded onto the base unit to cover the base unit when the portable computer is not in use. The cover unit includes a latch mechanism provided to lock the cover to the base unit.

As disclosed in China Patent No. 01208955.9, a portable computer includes a latch mechanism which acts to lock a cover unit to a base unit when the portable computer is not in use. The latch mechanism includes a hook for engaging in notches defined in the base unit, and a post movably embedded in the base unit for disengaging the hook from the base unit. An end portion of the post is exposed outside the base unit for facilitating pushing the post to disengage the hook from the base unit. However, the end portion of the post is liable to be accidentally touched resulting in an undesired opening of the cover.

What is desired, therefore, is a cover which has an improved latch mechanism.

### SUMMARY OF THE INVENTION

In one preferred embodiment, a latch mechanism includes a cover piece, and a latch member. The cover piece includes a base wall, and a flange extending perpendicularly from the base wall. The base wall includes a pair of slots defined therein, and a stop board. The flange includes a cutout defined therein. The latch member is slidably attached to the cover piece and includes a frame slidably received in the cutout of the flange, and a pair of arms having a pair of hooks depending therefrom to movably extend through the slots of the cover piece. The frame includes a rectangular hole defined therein, and a post extending into the hole from an inside wall thereof. A resilient member is fixed around the post and movably engages with the stop board.

Other advantages and novel features will become more apparent from the following detailed description of preferred embodiments when taken in conjunction with the accompanying drawings, in which:

### BRIEF DESCRIPTION OF THE DRAWINGS

FIG. 1 is an exploded, isometric view of a cover in accordance with a preferred embodiment of the present invention;

FIGS. 2 and 3 are assembled views of FIG. 1, but viewed from different aspects; and

FIG. 4 is a working schematic side view of the cover of FIG. 3, being attached to a base unit.

### DETAILED DESCRIPTION OF THE INVENTION

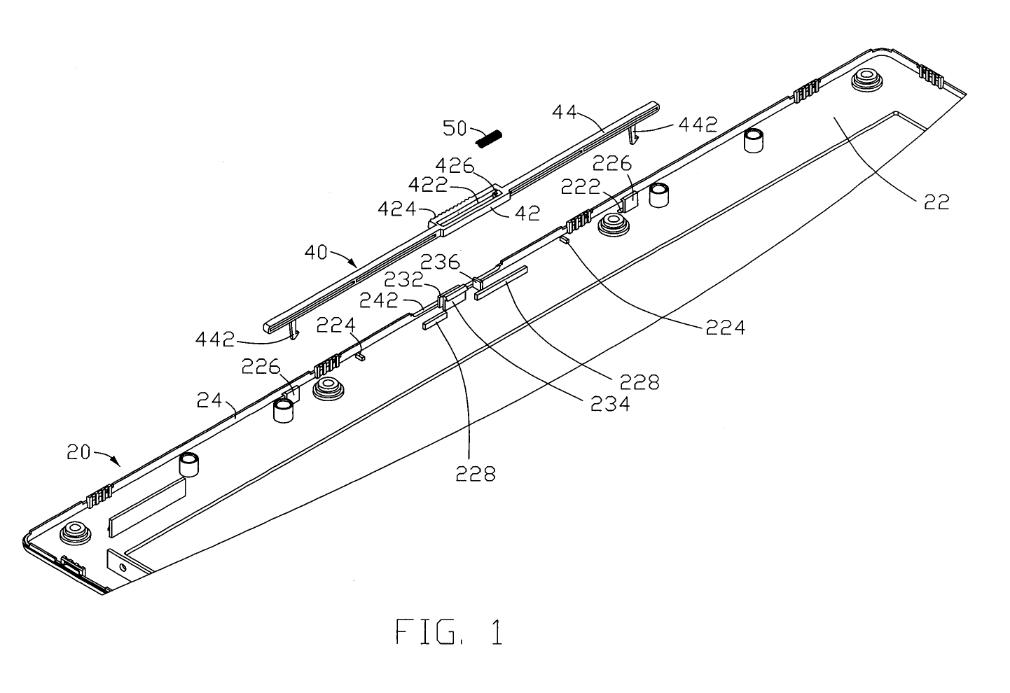

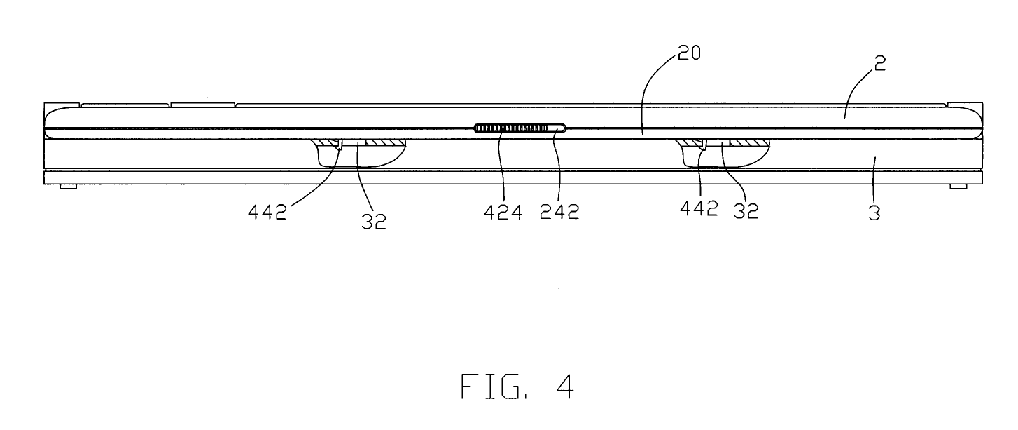

Referring to FIGS. 1 and 4, a latch mechanism in accordance with a preferred embodiment of the present invention is for locking a cover unit 2 to a base unit 3 of a portable electronic device such as a portable computer. The cover unit 2 is pivotably attached to the base unit 3. The latch mechanism includes a cover piece 20, and a latch member 40 slidably attached to the cover piece 20. The cover piece 20 is a lower part of the cover unit 2. The base unit 3 defines a pair of apertures 32 in a front portion thereof.

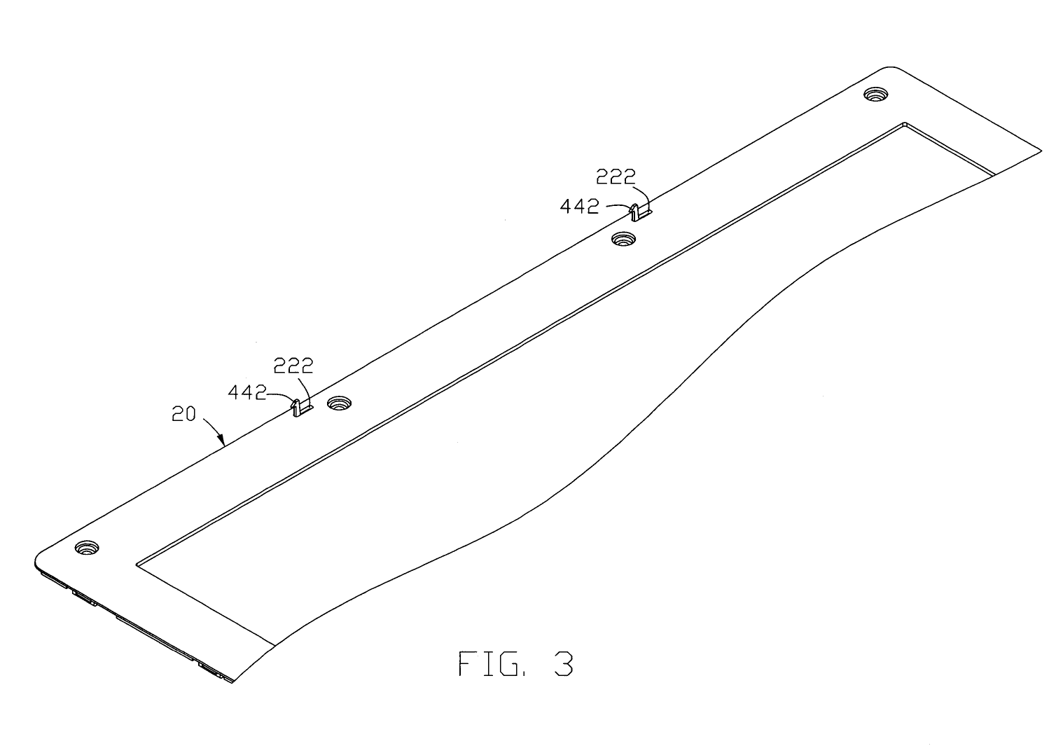

The cover piece 20 includes a base wall 22, and a flange 24 formed at a front edge of the base wall 22. A cutout 242 is defined in the flange 24 by cutting a portion from the flange 24. Referring also to FIG. 3, a pair of slots 222 is defined in the base wall 22, along the flange 24. A pair of supporting blocks 224 extends from the base wall 22 between the slots 222. A pair of first upright catches 226 respectively extends from the base wall 22 adjacent the slots 222 and toward the flange 24. A pair of spaced guiding bars 228 in alignment extends from the base wall 22, parallel to the flange 24 and adjacent the cutout 242 of the flange 24. A guiding tab 232 and a second upright catch 234 perpendicularly extend from the base wall 22 between the cutout 242 of the flange 24 and the guiding bars 228. The second upright catch 234 extends offset to the first catches 226. A stop board 236 perpendicularly extends from the base wall 22 and is perpendicular to the guiding tab 232 and the second catch 234.

The latch member 40 is bar-shaped, and includes a rectangular frame 42 at a middle thereof, and a pair of arms 44 extending from two opposite ends of the frame 42 respectively. The frame 42 includes a rectangular through hole 422 defined therein, and a handgrip portion 424 formed at an outer front surface thereof. A post 426 perpendicularly extends in from an inside surface of a right end of the frame 42, for fixing a resilient member 50 therearound. A pair of hooks 442 depends from the arms 44 respectively, corresponding to the slots 222 of the cover piece 20.

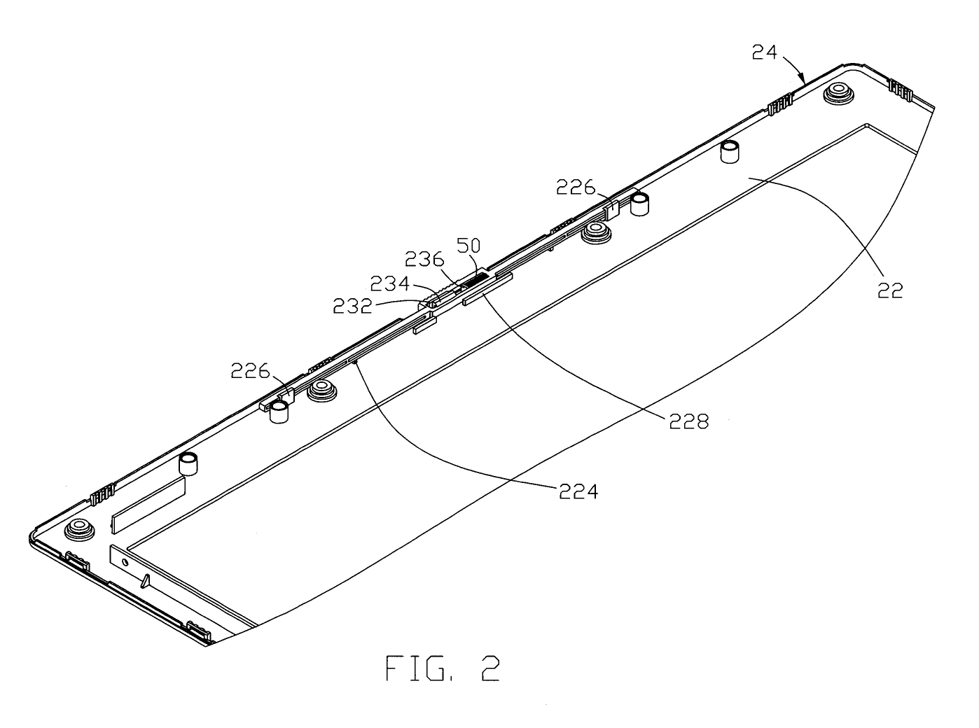

Referring to FIGS. 2 to and 4, in assembly, the latch member 40 is slidably attached to the cover piece 20, with the handgrip portion 424 exposed in the cutout 242 of the flange 24, for facilitating manipulation of the latch member 40. The resilient member 50 is fixed around the post 426 of the latch member 40. A free end of the resilient member 50 presses against the stop board 236. The guiding tab 232 and the second catch 234 extend through the through hole 422 of the frame 42. The guiding tab 232 slidably abuts against an outer sidewall of the frame 42, and the second catch 234 slidably engages with an inside wall of the frame 42 of the latch member 40. The guiding bars 228 slidably abut against a rear outer surface of the frame 42. The arms 44 of the latch member 40 are slidably placed on the supporting blocks 224 of the cover piece 20. The hooks 442 of the latch member 40 extend through the slots 222 of the base wall 22 of the cover piece 20. The first catches 226 of the cover piece 20 slidably engage with the arms 44 of the latch member 40. The second catch 234 slidably engages with an outer rear surface of the frame 42. The first catches 226 and the second catch 234 also slidably engage with top portions of the arms 44 and a top portion of the frame 42, preventing an upward movement of the latch member 40.

The cover piece 20 is then assembled with the cover unit 2. The cover unit 2 is pivotably attached to the base unit 3, and the cover unit 2 is folded to cover the base unit 3, with the hooks 442 engaging in the apertures 32 and latching to the base unit 2.

To open the cover unit 1 of the electronic device, the handgrip portion 424 of the latch member 40 is urged to the left compressing the resilient member 50 and disengaging the hooks 442 from the apertures 32 of the base unit 3. The cover unit 1 is ready to be opened. When the handgrip portion 424 is released, the resilient member 50 rebounds thus urging the latch member 40 back to its original position.

Numbers of the hooks 442 of the latch member 40 and the slots 222 of the cover piece 20 can be varied according to different situations. The latch member 40 can be slidably attached to any possible sidewalls of the cover unit 2 and base unit 3, with the handgrip portion 424 thereof exposed to be easily operated.

It is believed that the present embodiment and its advantages will be understood from the foregoing description, and it will be apparent that various changes may be made thereto without departing from the spirit and scope of the invention or sacrificing all of its material advantages, the example hereinbefore described merely being a preferred or exemplary embodiment.

What is claimed is:

1. A latch mechanism, comprising:
a cover piece comprising a base wall, and a flange extending from the base wall, the flange defining a cutout therein, the base wall defining a pair of slots therein, the base wall comprising at least one first catch, and a second catch cooperatively defining a sliding way; and
a latch member attached to the base wall and slidably engaging with said at least one first catch and said second catch, the latch member comprising a frame movably received in the cutout of the flange, and a pair arms extending from two ends of the frame, the arms having a pair of hooks depending therefrom and movably extending out of the slots of the cover piece.

2. The latch mechanism as claimed in claim 1, further comprising a resilient member, wherein the base wall comprises a stop board extending therefrom, the frame comprises a through hole defined therein, and a post extending into the hole from an inside wall thereof, the resilient member is fixed around the post of the frame and abuts against the stop board.

3. The latch mechanism as claimed in claim 1, wherein the frame comprises a handgrip portion formed at an outer surface, the handgrip portion is exposed in the cutout of the flange.

4. The latch mechanism as claimed in claim 1, wherein the base wall comprises a pair of supporting blocks extending therefrom, for slidably supporting the latch member thereon.

5. The latch mechanism as claimed in claim 1, wherein said at least one first catch and said second catch extend from the base wall oppositely, slidably engaging with sidewalls and top portions of the arms and the frame of the latch member.

6. The latch mechanism as claimed in claim 1, wherein the base wall comprises a guiding tab extending therefrom, corresponding to the cutout of the flange and slidably engaging with an inside surface of the frame.

7. The latch mechanism as claimed in claim 6, wherein the base wall comprises a guiding tab extending therefrom, corresponding to the cutout of the flange and slidably engaging with an inside surface of the frame.

8. A latch mechanism, comprising:
a cover piece comprising a base wall, and a flange extending from the base wall; the flange defining a cutout therein, the base wall defining at least one slot therein, the base wall comprising a plurality of catches extending perpendicularly therefrom;
a latch member slidably attached to the base wall and slidably engaging with the catches, the latch member comprising a handgrip portion exposed in the cutout of the flange, and at least one hook extending therefrom and movably extending out of said at least one slot of the cover piece ; and
a resilient member movably attaching the latch member to the cover piece.

9. The latch mechanism as claimed in claim 8, wherein the plurality of catches comprises a pair of first catches, and a second catch extending perpendicularly therefrom, the first catches are offset to the second catch, the first catches and the second catch cooperatively and slidably hold the latch member therebetween.

10. The latch mechanism as claimed in claim 9, wherein the first catches and second catch slidably engage with sidewalls and top edges of latch member.

11. The latch mechanism as claimed in claim 8, wherein the latch member comprises a frame movably received in the cutout of the flange, and at least one arm extending therefrom, said at least one hook depends from said at least one arm, the handgrip portion is formed at an outer front surface of the frame.

12. The latch mechanism as claimed in claim 11, wherein the base wall comprises a stop board extending therefrom, the frame defines a rectangular through hole therein, a post extends into the through hole from an inside wall of the frame, the resilient member fixed around the post of the frame and abuts against the stop board.

13. The latch mechanism as claimed in claim 12, wherein the base wall comprises a guiding tab extending therefrom, slidably receiving in the through hole and engaging with an inside surface of the frame.

14. The latch mechanism as claimed in claim 11, wherein the base wall comprises at least one supporting block extending therefrom, for slidably supporting said at least one arm of the latch member thereon.
